(19) United States
(12) Patent Application Publication
(10) Pub. No.: US 2013/0309912 A1
(43) Pub. Date: Nov. 21, 2013

(54) SOCKET CONNECTOR WITH SIGNAL CONTACTS

(71) Applicants: Hung-Chi TAI, Jhonghe (TW); Ya-Juan GOU, Taicang (CN)

(72) Inventors: Hung-Chi TAI, Jhonghe (TW); Ya-Juan GOU, Taicang (CN)

(73) Assignee: ALLTOP ELECTRONICS (SUZHOU) LTD., Taicang City (CN)

(21) Appl. No.: 13/559,185

(22) Filed: Jul. 26, 2012

(30) Foreign Application Priority Data
May 18, 2012 (CN) 201210154661

(51) Int. Cl. H01R 24/00

(52) U.S. Cl. 439/660

(57) ABSTRACT

A socket connector includes an insulative housing, at least one power contact received in the insulative housing, at least one ground contact received in the insulative housing and at least one signal contact received in the insulative housing. The insulative housing includes an upper wall, a lower wall opposite to the upper wall and a pair of lateral walls connecting the upper wall and the lower wall. The insulative housing includes a first receiving recess defined cooperatively by the upper wall, the lower wall and the lateral walls, a complementary section formed in the first receiving recess with a second receiving recess defined therein.

### BACKGROUND OF THE INVENTION

1. Field of the Invention

The present invention relates to an electrical connector, more particularly to a socket connector providing power transmission for computer.

2. Description of Related Art

Along with the rapid development of electrical appliances, the requirements to power connectors are increasing in daily life, hence the research for different kinds of power connectors is paid more and more attention to by manufacturers and researchers.

A socket connector in the conventional electrical connectors usually comprises an insulative housing and a plurality of power contacts received in the insulative housing. Only power transmission is conducted between the socket connector and a complementary plug connector, where no signal transmission is conducted at the same time. Hence, a lot of problems, such as not advantageous enough for market competition, unable to satisfy the different needs of customers, are confronted.

Hence, it is necessary to improve the conventional socket connector to address problems mentioned above.

### BRIEF SUMMARY OF THE INVENTION

Accordingly, an object of the present invention is to provide a socket connector which is capable of transmitting power and signal simultaneously.

In order to achieve the above-mentioned object, a socket connector comprises an insulative housing, at least one power contact received in the insulative housing, at least one ground contact received in the insulative housing and at least one signal contact received in the insulative housing. The insulative housing comprises an upper wall, a lower wall opposite to the upper wall and a pair of lateral walls connecting with the upper wall and the lower wall. The insulative housing comprises a first receiving recess defined by the upper wall, the lower wall and the lateral walls, a complementary section formed in the first receiving recess and defining a second receiving recess therein.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is an assembled, perspective view of a socket connector in accordance with the present invention;

FIG. 2 is an exploded, perspective view of the socket connector of FIG. 1;

FIG. 3 is a perspective view of an insulative housing of the socket connector shown in FIG. 1;

FIG. 4 is a view similar to FIG. 3, but from a different view;

FIG. 5 is a perspective view of a power contact of the socket connector shown in FIG. 1;

FIG. 6 is a perspective view of a ground contact of the socket connector shown in FIG. 1;

FIG. 7 is a perspective view of a detect contact of the socket connector shown in FIG. 1; and

FIG. 8 is a perspective view of signal contacts of the socket connector shown in FIG. 1.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Reference will be made to the drawing figures to describe the present invention in detail, wherein depicted elements are not necessarily shown to scale and wherein like or similar elements are designated by same or similar reference numeral through the several views and same or similar terminology.

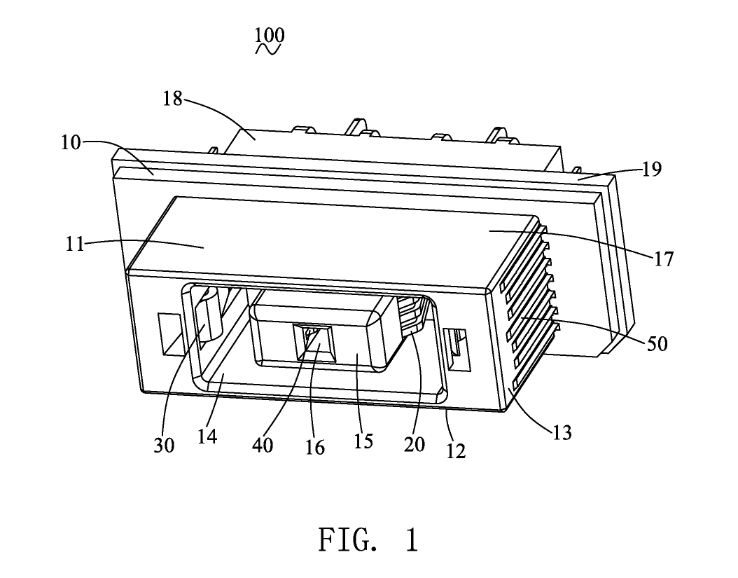

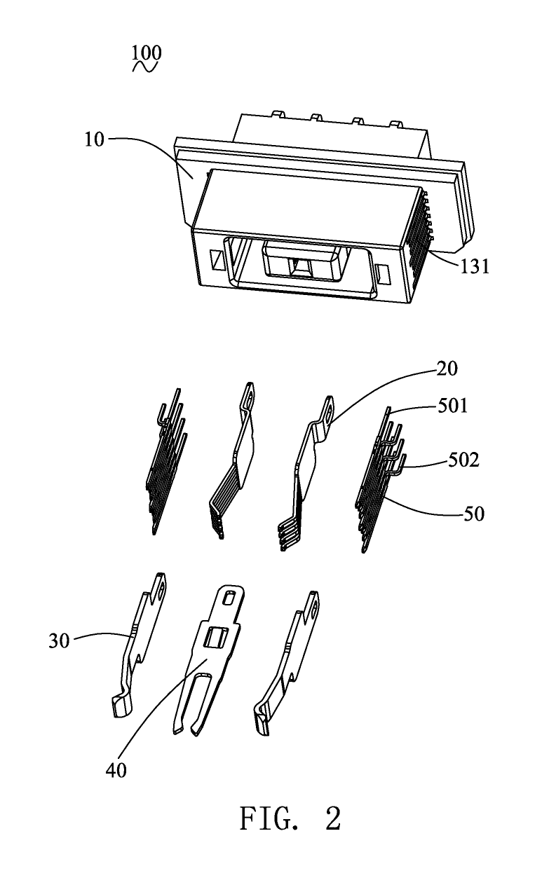

Please refer to FIGS. 1-2, a socket connector 100 in accordance with the present invention comprises an insulative housing 10, a plurality of contacts received in the insulative housing 10. The contacts comprise a plurality of power contacts 20, a plurality of ground contacts 30, a detect contact 40, and a plurality of signal contacts 50. In the preferred embodiment of the present invention, there are a pair of spaced power contacts 20 each located in a vertical surface and extending along front-to-rear direction, one detect contact 40 located between the pair of power contacts 20, and a pair of ground contacts 30 located at outer sides of the pair of power contacts 20 and substantially parallel to the power contacts 20. The detect contact 40 is located in a horizontal surface perpendicular to the vertical surface and extends along the front-to-rear direction.

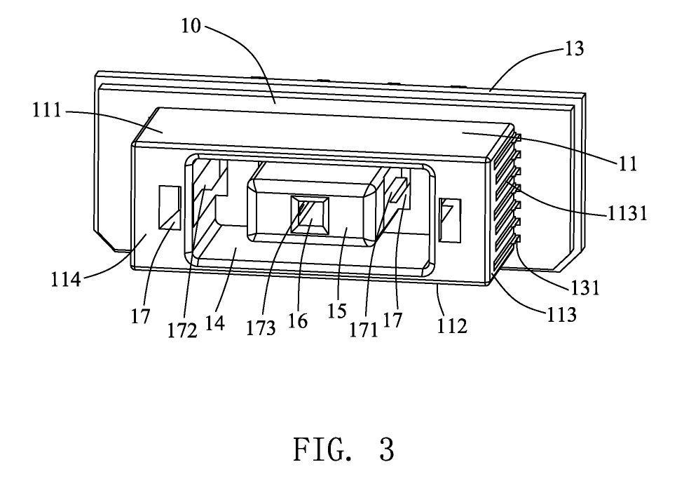

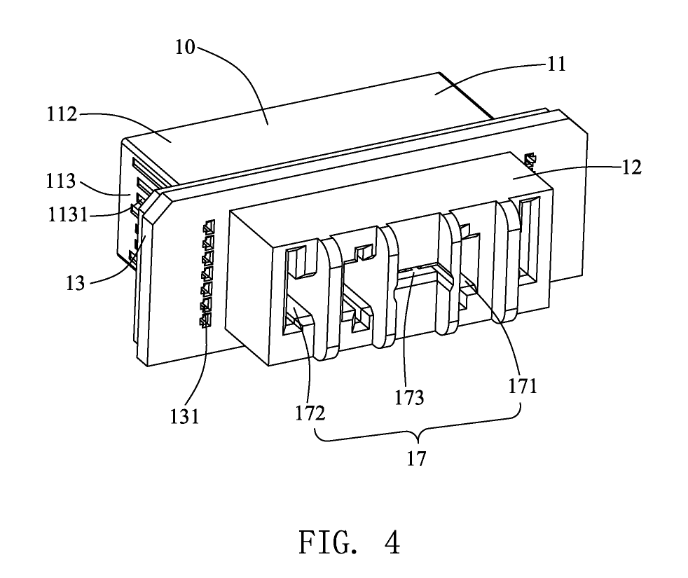

Please refer to FIGS. 3-4, the insulative housing 10 comprises a an upper wall 111, a lower wall 112 opposite to the upper wall 111, and a pair of lateral walls 113 connecting the upper wall 111 and the lower wall 112. A first receiving recess 14 is defined by the upper wall 111, the lower wall 112 and the lateral walls 113. A column-shape complementary section 15 is disposed in the first receiving recess 14 and defines a second receiving recess 16. The insulative housing 10 comprises a main portion 11, a stretch portion 12 extending rearwardly from the main portion 11, and a mounting panel 13 disposed between the main portion 11 and the stretch portion 12. Each lateral wall 113 defines a plurality of receiving slots 1131 which open toward the outside on an outer surface thereof. The mounting panel 13 defines a plurality of receiving channels 131 penetrating through the mounting panel 13, and the receiving slots 1131 and the receiving channels 131 align with one another respectively. In other words, the receiving slot 1131 and corresponding receiving channel 131 communicate with each other. A front surface 114 of the main portion 11 is arranged asymmetrically for preventing mis-mating when a complementary plug connector (not shown) mates with the socket connector 100.

The insulative housing 10 defines a plurality of contact-receiving passages 17 for receiving the power contacts 20, the ground contacts 30, the detect contact 40. The contact-receiving passages 17 are divided into a pair of first contact-receiving passages 171 defined on opposite sides of the complementary section 15 and communicating with the first receiving recess 14 for receiving the power contacts 20, a pair of second contact-receiving passages 172 defined on opposite inner sides of the lateral walls 113 and communicating with the first receiving recess 14 for receiving the ground contacts 30, and a third contact-receiving passage 173 defined in the second receiving recess 16 for receiving the detect contact 40. The contact-receiving passages 17 are all defined through the main portion 11, the mounting panel 13 and the stretch portion 12 for radiating the heat generated in the insulative housing 10 by the power contacts 20, the ground contacts 30, and the detect contact 40 during mating. Since the shapes of the power contacts 20, the ground contacts 30 and the detect contact 40 are different from one another, the shapes of the contact-receiving passages 171, 172, 173 are also different from one another.

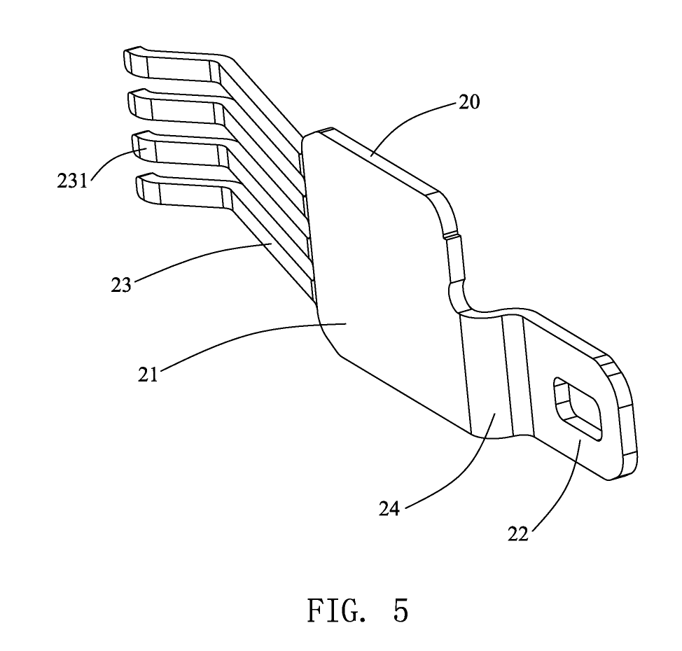

Please refer to FIG. 5 in combination with FIG. 1, the power contacts 20 are received in the first contact-receiving passages 171 defined in the complementary section 15 and partially exposed to the first receiving recess 14. Each power contact 20 comprises a first base section 21, a first tail section 22 extending from a rear end of the first base section 21 and parallel to the first base section 21 via a bent section 24 which connects the both, and a first contacting section 23 extending from a front end of the first base section 21. In the preferred embodiment of the present invention, the first contacting section 23 has four parallel curved contacting beams 231 for improving the contact reliability when the socket connector 100 of the present invention mates with the complementary plug connector.

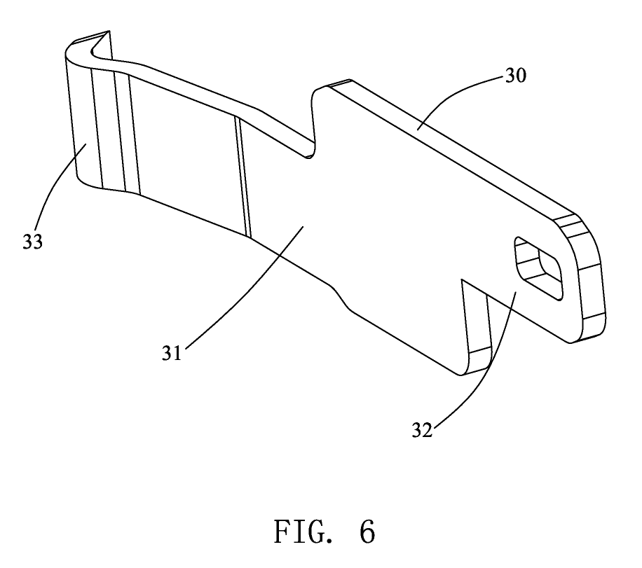

Please refer to FIG. 6 in conjunction with FIG. 1, the ground contacts 30 are received in the second contact-receiving passages 172 defined on the inner sides of the lateral walls 113 and partially exposed in the first receiving recess 14. Each ground contact 30 comprises a flat second base section 31, a second tail section 32 extending rearwardly from a rear end of the second base section 31, and a curved second contacting section 33 extending from a front end of the second base section 31.

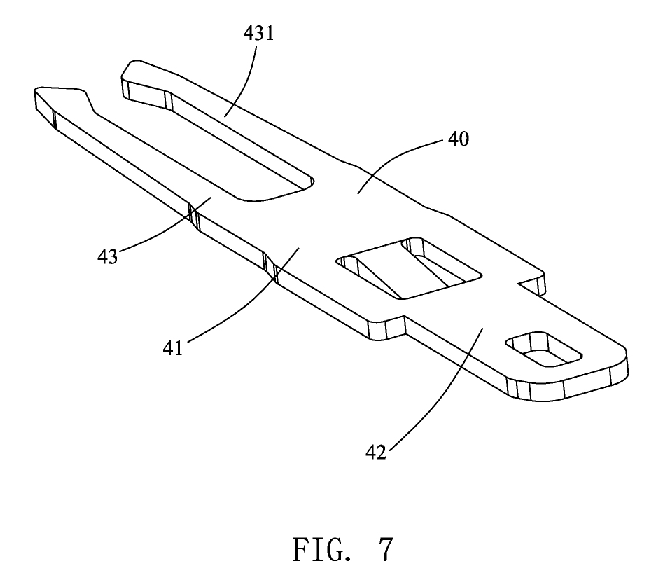

Please refer to FIG. 7 in conjunction with FIG. 1, the detect contact 40 is received in the third contact-receiving passage 173 which is defined in the second receiving recess 16. The detect contact 40 comprises a third base section 41, a third tail section 42 extending from a rear end of the third base section 41, and a third contacting section 43 extending from a front end of the third base section 41. In the preferred embodiment of the present invention, the third contacting section 43 is bifurcated and has pair of contacting beams 431 respectively located on inner walls of the complementary section 15 and partially exposed into the second receiving recess 16.

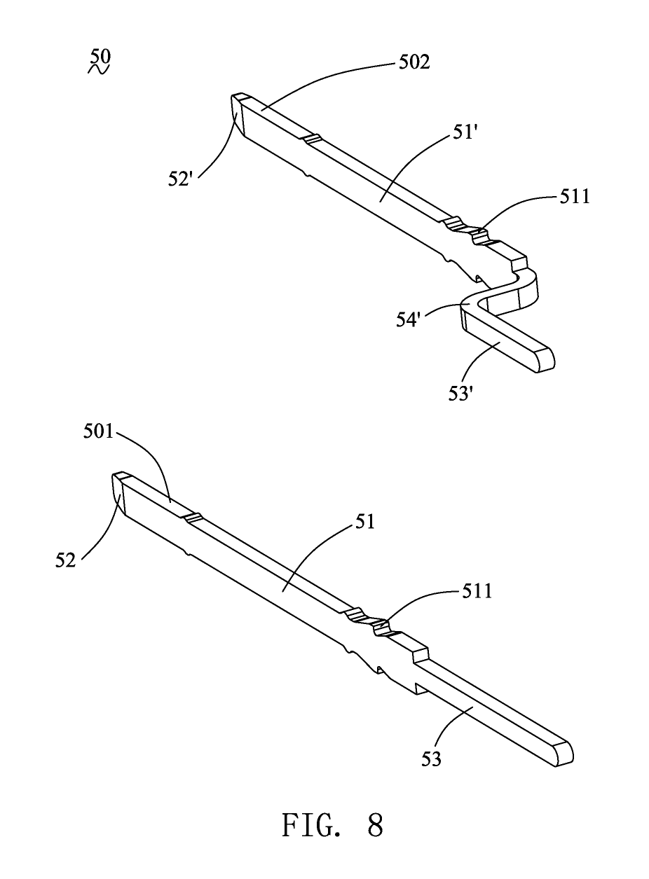

Please refer to FIG. 8 in conjunction with FIGS. 1-2, the signal contacts 50 are divided into two groups with each group comprising a plurality of signal contacts 50 aligned with one another along a vertical/up-to-down direction. The signal contacts 50 are assembled to the pair of lateral walls 113 and the mounting panel 13. Each group of signal contacts 50 comprise several first signal contacts 501 and several second signal contacts 502 arranged alternatively along the vertical direction. The first signal contact 501 comprises a flat intermediate section 51, a mating section 52 extending from a front end of the intermediate section 51, and a termination section 53 extending from a rear end of the intermediate section 51. The second signal contact 502 comprises a flat intermediate section 51′, a mating section 52′ extending from a front end of the intermediate section 51′, and a termination section 53′ extending from a rear end of the intermediate section 51′ and substantially parallel to the intermediate section 51′ via a bent section 54′. Although the termination sections 53, 53′ of the first and second contacts 501, 502 are different, however, in an alternative embodiment, the first and second contacts 501, 502 could have the same configuration. The mating sections 52, 52′ are received in the receiving slots 1131 in the lateral walls 113 and exposed to the outside. The intermediate sections 51, 51′ are retained in the receiving channels 131 of the mounting panel 13 with barbs 511 formed on opposite edges thereof interferentially engaging with inner walls of the receiving channels 131. Thus, the signal contacts 50 are reliably retained in the lateral walls 113 of the insulative housing 10.

In summary, the socket connector 100 in accordance with the present invention, via assembling the signal contacts 50 to the lateral walls 113 of the insulative housing 10, realizes transmitting power and signal simultaneously and simply assembly of the signal contacts 50.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed. For example, the tongue portion is extended in its length or is arranged on a reverse side thereof opposite to the supporting side with other contacts but still holding the contacts with an arrangement indicated by the broad general meaning of the terms in which the appended claims are expressed.

What is claimed is:

1. A socket connector, comprising:
an insulative housing comprising an upper wall, a lower wall opposite to the upper wall and a pair of lateral walls connecting the upper wall and the lower wall, the insulative housing comprises a first receiving recess defined cooperatively by the upper wall, the lower wall and the lateral walls, a complementary section formed in the first receiving recess with a second receiving recess defined therein;
at least one power contact received in the insulative housing;
at least one ground contact received in the insulative housing; and
at least one signal contact received in the insulative housing.

2. The socket connector as claimed in claim 1, wherein the at least one signal contact is a plurality of signal contacts assembled to at least one lateral wall of the insulative housing, wherein each signal contact comprises an intermediate section, a mating section extending from one end of the intermediate section and a termination section extending from the other end of the intermediate section.

3. The socket connector as claimed in claim 2, wherein the signal contacts are aligned in one line along an outer surface of the at least one lateral wall.

4. The socket connector as claimed in claim 2, wherein the signal contacts are divided into a plurality of first signal contacts assembled to one lateral wall of the insulative housing and a plurality of second contacts assembled to the other lateral wall of the insulative housing.

5. The socket connector as claimed in claim 4, wherein the signal contacts are assembled to opposite outer surfaces of the pair of lateral walls.

6. The socket connector as claimed in claim 2, wherein the insulative housing comprises a front main portion defining a plurality of receiving slots in the at least one lateral wall, a rear stretch portion, and a mounting panel located between the main portion and the stretch portion, and wherein the intermediate sections of the signal contacts are interferentally received in the mounting panel, the mating sections of the signal contacts are received in the receiving slots in the at least one lateral wall, and the termination sections are exposed beyond the mounting panel.

7. The socket connector as claimed in claim 2, wherein the at least one power contact is a pair of power contacts positioned on opposite outer sides of the complementary section of the insulative housing and partially exposed into the first receiving recess.

8. The socket connector as claimed in claim 7, wherein at least one ground contact is a pair of ground contacts positioned on opposite inner sides of the lateral walls of the insulative housing and partially exposed into the first receiving recess.

9. The socket connector as claimed in claim 8, wherein the ground contacts and the power contacts are substantially parallel to each other and each substantially located in a vertical surface and extending along front-to-rear direction.

10. The socket connector as claimed in claim 9, further comprising a detect contact located in a horizontal surface perpendicular to the vertical surface, wherein the pair of power contacts are located between the pair of ground contacts with the detect contact located between the pair of power contacts.

11. The socket connector as claimed in claim 10, wherein the detect contact is assembled in the second receiving recess and comprises a bifurcated contacting section.

12. The socket connector as claimed in claim 7, wherein each power contact comprises a first base section, a first tail section extending from one end of the first base section and parallel to the first base section via a bent section connecting the first base section and the first tail section, and a first contacting section extending from the other end of the first base section.

13. The socket connector as claimed in claim 12, wherein the first contacting section comprises four curved contacting beams.

14. The socket connector as claimed in claim 8, wherein each ground contact comprises a second base section, a second tail section extending from one end of the second base section, and a curved second contacting section extending from the other end of the second base section.

15. A socket connector, comprising:
an insulative housing comprising an upper wall, a lower wall opposite to the upper wall and a pair of lateral walls connecting with the upper wall and the lower wall, the insulative housing comprises a first receiving recess defined cooperatively by the upper wall, the lower wall and the lateral walls, a complementary section formed in the first receiving recess with a second receiving recess defined therein;
a pair of power contacts located at opposite side of the complementary section and partially exposed into the first receiving recess;
a pair of ground contacts located at opposite inner sides of the pair of lateral walls and partially exposed into the first receiving recess; and
at least one signal contact located at an outer side of at least one lateral wall.

16. The socket connector as claimed in claim 15, further comprising a detect contact received in the second receiving recess of the complementary section of the insulative housing.

17. The socket connector as claimed in claim 16, wherein the power contacts and the ground contacts are parallel to each other and located in a vertical surface, and the detect contact is located in a horizontal surface perpendicular to the vertical surface.

18. The socket connector as claimed in claim 15, wherein the at least one signal contact are a plurality of first contacts assembled to one lateral wall of the insulative housing, and a plurality of second contacts assembled to the other lateral wall of the insulative housing, and wherein the first contacts and the second contacts are respectively aligned in one line along corresponding lateral wall.
